(19) United States
(12) Patent Application Publication
(10) Pub. No.: US 2018/0136719 A1
(43) Pub. Date: May 17, 2018

(54) IMAGE BRIGHTNESS ADJUSTING METHOD AND IMAGE BRIGHTNESS ADJUSTING DEVICE

(71) Applicant: Wuhan China Star Optoelectronics Technology Co., Ltd., Wuhan (CN)

(72) Inventor: Yilin CHEN, (US)

(21) Appl. No.: 15/323,734

(22) PCT Filed: Dec. 23, 2016
(86) PCT No.: PCT/CN2016/111616

§ 371 Date: Jan. 4, 2017

(30) Foreign Application Priority Data
Nov. 16, 2016 (CN) 201611032457.6

(51) Int. Cl. G06F 3/01; G09G 5/10; G09G 3/3208

(52) U.S. Cl. CPC G06F 3/013; G09G 5/10; G09G 2330/023; G09G 2354/00; G09G 2320/08; G09G 3/3208

(57) ABSTRACT

An image brightness adjusting method is provided. The image brightness adjusting method comprises determining a focus point of the user on a display screen of the OLED display device according to the focus sighting of the user; determining at least one adjustable brightness display area in the user's focus according to the focus point and an eye resolution range; and setting a screen display brightness of each of the adjustable brightness display areas according to positions of the adjustable brightness display areas in the user's focus.

### FIELD OF THE INVENTION

The present invention relates to display technology, and more particularly to an image brightness adjusting method and an image brightness adjusting device for a display.

### BACKGROUND OF THE INVENTION

OLED display technology has become the mainstream display technology. Currently, in the OLED driving manner, a power consumption of the OLED display is proportional to a brightness of the OLED display. As long as the brightness of the OLED display is dim, the power consumption of the OLED display is low. It is possible to reduce the power consumption of the OLED display device by lowering the brightness of the OLED display.

Current OLED display devices can provide different local voltages for different areas of the display panel, thereby providing different levels of brightness for the OLED display based on a user's habits and usage scenarios for different areas of the display. For example, the user's attention is higher in the central area of the OLED screen, so a higher brightness is set in the central area of the OLED display. The user's attention is lower on the edge areas of the OLED screen, so a lower brightness is set in the edge areas of the OLED display.

However, the setting method of the aforementioned brightness of different areas of the OLED screen is absolute. Although it can better reduce the power consumption of the OLED display device, in some situations, it is not possible to highlight the area of the OLED screen with high user attention. When the user enters a user name and password at the top of a web page and if the input box cannot be moved to the middle of the screen, the user must key in the user name and password in an area with lower brightness.

Thus, it is necessary to provide an image brightness adjusting method and an image brightness adjusting device to solve the problems of the prior art.

### SUMMARY OF THE INVENTION

The embodiment of the present invention provides an image brightness adjusting method and an image brightness adjusting device for better lowering the power consumption of the OLED display device while not affecting the user's experience to solve the problems of higher power consumption in the conventional image brightness adjusting method and image brightness adjusting device, or to solve the problems affecting the user's experience.

The embodiment of the present invention provides an image brightness adjusting method for adjusting an image display brightness of an OLED display device. The OLED display device includes a plurality of adjustable brightness display areas and an eye movement camera, the method comprises:

obtaining a focus sighting of a user through the eye movement camera;

determining a focus point of the user on a display screen of the OLED display device according to the focus sighting of the user;

determining at least one adjustable brightness display area in the user' focus according to the focus point and an eye resolution range; and

setting a screen display brightness of each of the adjustable brightness display areas according to positions of the adjustable brightness display areas in the user's focus;

wherein the screen display brightness of the adjustable brightness display areas closer to the focus point is greater than the screen display brightness of the adjustable brightness display areas far away from the focus point;

wherein the step of setting the screen display brightness of each of the adjustable brightness display areas according to the positions of the adjustable brightness display areas of the user's focus comprises:

setting the screen display brightness of each of the adjustable brightness display areas according to the positions of the adjustable brightness display areas in the user's focus and a user's focus duration;

wherein when the user's focus duration in the adjustable brightness display areas in the user's focus is greater than or equal to a second setting value, the screen display brightness of the adjustable brightness display areas outside of the adjustable brightness display area which the user focuses on is lowered.

The embodiment of the present invention further provides an image brightness adjusting method for adjusting an image display brightness of an OLED display device. The OLED display device includes a plurality of adjustable brightness display areas and an eye movement camera. The method comprises:

obtaining a focus sighting of a user through the eye movement camera;

determining a focus point of the user on a display screen of the OLED display device according to the focus sighting of the user;

determining at least one adjustable brightness display area in the user's focus according to the focus point and an eye resolution range; and

setting a screen display brightness of each of the adjustable brightness display areas according to positions of the adjustable brightness display areas in the user's focus.

In the image brightness adjusting method of the present invention, the screen display brightness of the adjustable brightness display areas closer to the focus point is greater than the screen display brightness of the adjustable brightness display areas far away from the focus point.

In the image brightness adjusting method of the present invention, the step of setting the screen display brightness of each of the adjustable brightness display areas according to the positions of the adjustable brightness display areas in the user's focus comprises:

setting the screen display brightness of each of the adjustable brightness display areas according to the positions of the adjustable brightness display areas in the user's focus and a preset brightness reduction curve.

In the image brightness adjusting method of the present invention, the image brightness adjusting method further comprises: adjusting the preset brightness reduction curve.

In the image brightness adjusting method of the present invention, the step of setting the screen display brightness of each of the adjustable brightness display areas according to the positions of the adjustable brightness display areas in the user's focus comprises:

setting the screen display brightness of the adjustable brightness display area whose distance from the focus point is greater than or equal to a first setting value to zero.

In the image brightness adjusting method of the present invention, the step of setting the screen display brightness of each of the adjustable brightness display areas according to the positions of the adjustable brightness display areas of the user's focus comprises:

setting the screen display brightness of each of the adjustable brightness display areas according to the positions of the adjustable brightness display areas in the user's focus and a user's focus duration.

In the image brightness adjusting method of the present invention, when the user's focus duration in the adjustable brightness display areas in the user's focus is greater than or equal to a second setting value, the screen display brightness of the adjustable brightness display area outside of the adjustable brightness display area which the user focuses on is lowered.

The embodiment of the present invention further provides an image brightness adjusting device for adjusting an image display brightness of an OLED display device. The OLED display device includes a plurality of adjustable brightness display areas and an eye movement camera, the image brightness adjusting device comprises:

a focus sighting obtaining module for obtaining a focus sighting of a user through the eye movement camera;

a focus point determining module for determining the user's focus point on a display screen of the OLED display device according to the focus sighting of the user;

a user's focus display area determining module for determining at least one adjustable brightness display area in the user's focus according to the focus point and an eye resolution range; and

an image brightness setting module for setting a screen display brightness of each of the adjustable brightness display areas according to positions of the adjustable brightness display areas in the user's focus.

In the image brightness adjusting device of the present invention, the screen display brightness of the adjustable brightness display areas closer to the focus point is greater than the screen display brightness of the adjustable brightness display areas far away from the focus point.

In the image brightness adjusting device of the present invention, the image brightness setting module is configured for setting the screen display brightness of each of the adjustable brightness display areas according to the positions of the adjustable brightness display areas in the user's focus and a preset brightness reduction curve.

In the image brightness adjusting device of the present invention, the image brightness adjusting device further comprises: an adjustment module for adjusting the preset brightness reduction curve.

In the image brightness adjusting device of the present invention, the image brightness setting module is configured for setting the screen display brightness of the adjustable brightness display area whose distance from the focus point is greater than or equal to a first setting value to zero.

In the image brightness adjusting device of the present invention, the image brightness setting module is configured for setting the screen display brightness of each of the adjustable brightness display areas according to the positions of the adjustable brightness display areas in the user's focus and a user's focus duration.

In the image brightness adjusting device of the present invention, when the user's focus duration in the adjustable brightness display areas in the user's focus is greater than or equal to a second setting value, the screen display brightness of the adjustable brightness display area outside of the adjustable brightness display area on which the user focuses is lowered.

Compared with the conventional image brightness adjusting method and image brightness adjusting device, the present invention provides an image brightness adjusting method and an image brightness adjusting device for adjusting a screen display brightness of each of the adjustable brightness display areas according to the user's focus sighting, thereby better lowering the power consumption of the OLED display device and not affecting the user's experience. The present invention solves the problems of higher power consumption and the problems affecting the user's experience of the conventional image brightness adjusting method and image brightness adjusting device.

In order to more clearly describe the embodiments of the present invention, the following description is used to make a simple introduction of the drawings used in the following embodiments.

### DESCRIPTION OF THE DRAWINGS

FIG. 1 is a flow chart of an image brightness adjusting method according to a first preferred embodiment of the present invention.

FIG. 2 is a flow chart of the image brightness adjusting method according to a second preferred embodiment of the present invention.

FIG. 3 is a structural schematic view of an image brightness adjusting device according to the first preferred embodiment of the present invention.

FIG. 4 is a structural schematic view of an image brightness adjusting device according to the second preferred embodiment of the present invention.

### DETAILED DESCRIPTION OF THE PREFERRED EMBODIMENTS

This description of the exemplary embodiments is intended to be read in connection with the accompanying drawings, which are to be considered part of the entire written description. In the description, terms such as “lower”, “upper”, “horizontal”, “vertical”, “above”, “below”, “up”, “down”, “top”, and “bottom”, as well as derivatives thereof, should be construed to refer to the orientation as then described or as shown in the drawing under discussion. These terms are for convenience of description and do not require that the apparatus be constructed or operated in a particular orientation, and do not limit the scope of the invention.

Referring to the drawings of the present invention, similar components are labeled with the same number.

An image brightness adjusting method and an image brightness adjusting device of the present invention are disclosed for adjusting a screen display brightness of an OLED display device. The OLED display device comprises a plurality of adjustable brightness display areas and an eye movement camera. The image brightness adjusting method and the image brightness adjusting device of the present invention are disclosed for adjusting the screen display brightness of each of the adjustable brightness display areas according to the user's focus sighting, thereby better lowering the power consumption of the OLED display device and not affecting the user's experience.

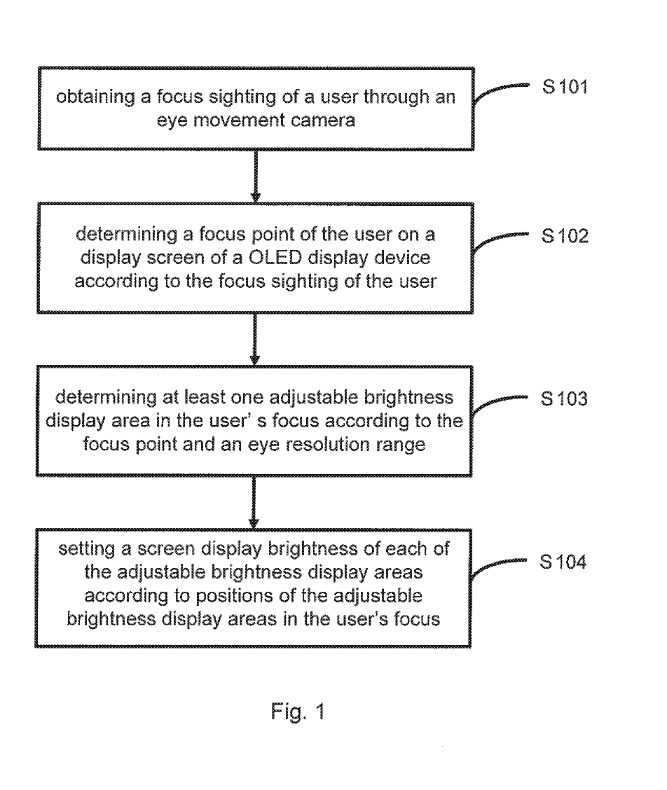

Refer to FIG. 1, which is a flow chart of an image brightness adjusting method according to a first preferred embodiment of the present invention. The image brightness adjusting method of the preferred embodiment can be carried out by using the aforementioned OLED display device. The image brightness adjusting method comprises:

step S101: obtaining a focus sighting of a user through the eye movement camera;

step S102: determining a focus point of the user on a display screen of the OLED display device according to the focus sighting of the user;

step S103: determining at least one adjustable brightness display area in the user's focus according to the focus point and an eye resolution range;

step S104: setting a screen display brightness of each of the adjustable brightness display areas according to positions of the adjustable brightness display areas in the user's focus.

The following description describes the specific process of the image brightness adjusting method of the preferred embodiment in detail.

In the step S101, the image brightness adjusting device is used for obtaining a focus sighting of a user, which is a viewing direction of the user, through the eye movement camera. Then the method proceeds to step S102.

In the step S102, the image brightness adjusting device is used for determining a focus point of the user on a display screen of the OLED display device according to the focus sighting of the user described in the step S101. Namely, when the user employs the OLED display device, the focus point of the user is a location where the user's eye focuses on the display screen. Then the method proceeds to step S103.

In the step S103, the image brightness adjusting device is used for determining one or a plurality of adjustable brightness display areas on which the user is focused according to the focus point described in the step S102 and an eye resolution range. Namely, the adjustable brightness display areas within the scope of human eye resolution around the focus point are set as the adjustable brightness display areas on which the user is focused. Then the method proceeds to step S104.

In the step S104, the image brightness adjusting device is used for setting a screen display brightness of each of the adjustable brightness display areas according to positions of the adjustable brightness display areas on which the user is focused. Specifically, the screen display brightness of the adjustable brightness display areas closer to the focus point is greater than the screen display brightness of the adjustable brightness display areas far away from the focus point.

Thus, the image brightness adjusting process of the image brightness adjusting method of the preferred embodiment is completed.

The image brightness adjusting method of the preferred embodiment is used for adjusting the screen display brightness of each of the adjustable brightness display areas according to the user's focus sighting, thereby better lowering the power consumption of the OLED display device and not affecting the user's experience.

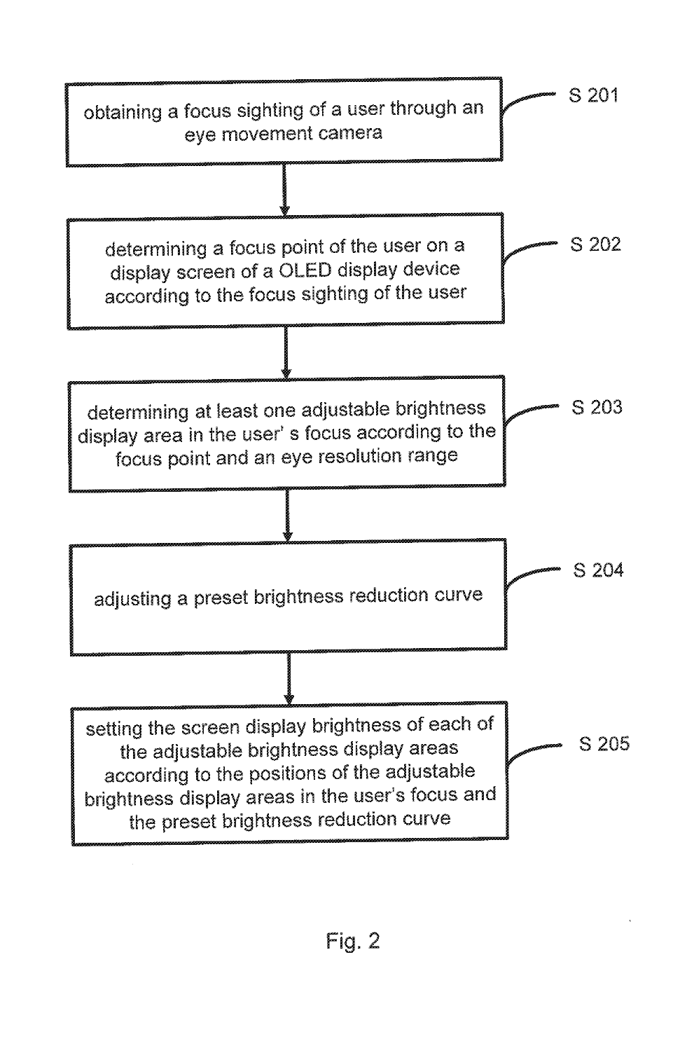

Refer to FIG. 2, which is a flow chart of an image brightness adjusting method according to a second preferred embodiment of the present invention. The image brightness adjusting method of the preferred embodiment can be carried out by using the aforementioned OLED display device. The image brightness adjusting method comprises:

step S201: obtaining a focus sighting of a user through the eye movement camera;

step S202: determining a focus point of the user on a display screen of the OLED display device according to the focus sighting of the user;

step S203: determining at least one adjustable brightness display area in the user's focus according to the focus point and an eye resolution range;

step S204: adjusting the preset brightness reduction curve;

step S205: setting the screen display brightness of each of the adjustable brightness display areas according to the positions of the adjustable brightness display areas in the user's focus and a preset brightness reduction curve.

The following description describes the specific process of the image brightness adjusting method of the preferred embodiment in detail.

In the step S201, the image brightness adjusting device is configured for obtaining a focus sighting of a user, which is a viewing direction of the user, through the eye movement camera. Then the method proceeds to step S102.

In the step S202, the image brightness adjusting device is configured for determining a focus point of the user on a display screen of the OLED display device according to the focus sighting of the user described in the step S201. Namely, when the user employs the OLED display device, the focus point is a location where the user's eye focuses on the display screen. Then the method proceeds to step S203.

In the step S203, the image brightness adjusting device is configured for determining one or a plurality of adjustable brightness display areas on which the user focused according to the focus point described in the step S202 and an eye resolution range. Namely, the adjustable brightness display areas within the scope of human eye resolution around the focus point are set as the adjustable brightness display areas on which the user is focused. Then the method proceeds to step S204.

In the step S204, the preset brightness reduction curve is adjusted by the user. The preset brightness reduction curve refers to a brightness difference curve between the adjustable brightness display areas on which the user's eye is focuses and the surrounding adjustable brightness display area thereof. The screen display brightness of the adjustable brightness display area is gradually decreased from the focus point outward. The user can adjust a decreasing ratio of the screen display brightness of the adjustable brightness display area by setting the preset brightness reduction curve, such as accelerating a brightness reducing rate or slowing down the brightness reducing rate, etc. Then the method proceeds to step S205.

In the step S205, the image brightness adjusting device is configured for setting the screen display brightness of each of the adjustable brightness display areas according to the positions of the adjustable brightness display areas in the user's focus and the preset brightness reduction curve obtained in the step S204. Specifically, the screen display brightness of the adjustable brightness display areas closer to the focus point is greater than the screen display brightness of the adjustable brightness display areas far away from the focus point.

Preferably, in the preferred embodiment, the screen display brightness of the adjustable brightness display area whose distance from the focus point is greater than or equal to a first setting value can be set to zero. This is equivalent to reducing the display panel of the OLED display device, so that the power consumption of the OLED display device can be further reduced.

Preferably, in the step S205, the image brightness adjusting device is further configured for setting the screen display brightness of each of the adjustable brightness display areas according to the positions of the adjustable brightness display areas in the user's focus and a user's focus duration.

Specifically, when the user's focus duration of the adjustable brightness display areas in the user's focus is greater than or equal to a second setting value, meaning the user's attention to the other adjustable brightness display areas is relatively low, the screen display brightness of the adjustable brightness display areas outside of the adjustable brightness display area on which the user is focused is lowered, thereby further reducing the power consumption of the OLED display device.

Thus, the image brightness adjusting process of the image brightness adjusting method of the preferred embodiment is completed.

On the basis of the first preferred embodiment, the image brightness adjusting method of the preferred embodiment allows the preset brightness reduction curve to be adjusted, which increases an adjustment flexibility of the screen display brightness of the adjustable brightness display area. Simultaneously, the screen display brightness of part of the adjustable brightness display area can be set to zero. Alternately, the screen display brightness of part of the adjustable brightness display area can be lowered according to a user's focus duration, thereby further reducing the power consumption of the OLED display device.

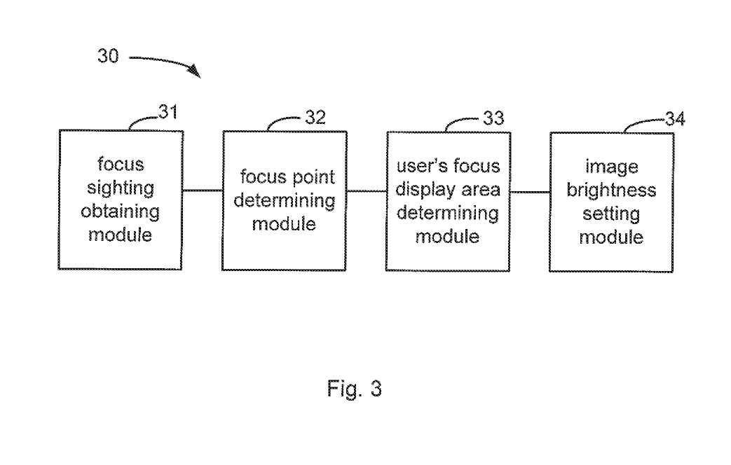

The present invention further provides an image brightness adjusting device. Referring to FIG. 3, it is a structural schematic view of an image brightness adjusting device according to the first preferred embodiment of the present invention. The first preferred embodiment of the device can carry out the aforementioned first preferred embodiment of the image brightness adjusting method. The image brightness adjusting device 30 comprises a focus sighting obtaining module 31, a focus point determining module 32, a user's focus display area determining module 33, and an image brightness setting module 34.

The focus sighting obtaining module 31 is configured for obtaining a focus sighting of a user through the eye movement camera. The focus point determining module 32 is configured for determining a focus point of the user on a display screen of the OLED display device according to the focus sighting of the user. The user's focus display area determining module 33 is configured for determining at least one adjustable brightness display area in the user's focus according to the focus point and an eye resolution range. The image brightness setting module 34 is configured for setting a screen display brightness of each of the adjustable brightness display areas according to positions of the adjustable brightness display areas in the user's focus.

When the image brightness adjusting device 30 of the preferred embodiment is used, firstly, the focus sighting obtaining module 31 obtains a focus sighting of the user, which is a viewing direction of the user, through the eye movement camera.

Then, the focus point determining module 32 determines the focus point of the user on the display screen of the OLED display device according to the focus sighting of the user obtained from the focus sighting obtaining module 31. Namely, the focus point is a location where the user's eye focuses on the display screen when the user employs the OLED display device.

Thereafter, the user's focus display area determining module 33 determines one or a plurality of adjustable brightness display areas on which the user is focused according to the focus point obtained from the focus point determining module 32 and an eye resolution range. Namely, the adjustable brightness display areas within the scope of human eye resolution around the focus point are set as the adjustable brightness display areas on which the user is focused.

Finally, the image brightness setting module 34 is configured for setting a screen display brightness of each of the adjustable brightness display area according to positions of the adjustable brightness display areas where the user's focuses on. Specifically, the screen display brightness of the adjustable brightness display areas closer to the focus point is greater than the screen display brightness of the adjustable brightness display areas far away from the focus point.

Thus, the image brightness adjusting process of the image brightness adjusting device 30 of the preferred embodiment is completed.

The image brightness adjusting device of the preferred embodiment is configured for adjusting the screen display brightness of each of the adjustable brightness display areas according to the user's focus sighting, thereby better lowering the power consumption of the OLED display device and not affecting the user's experience.

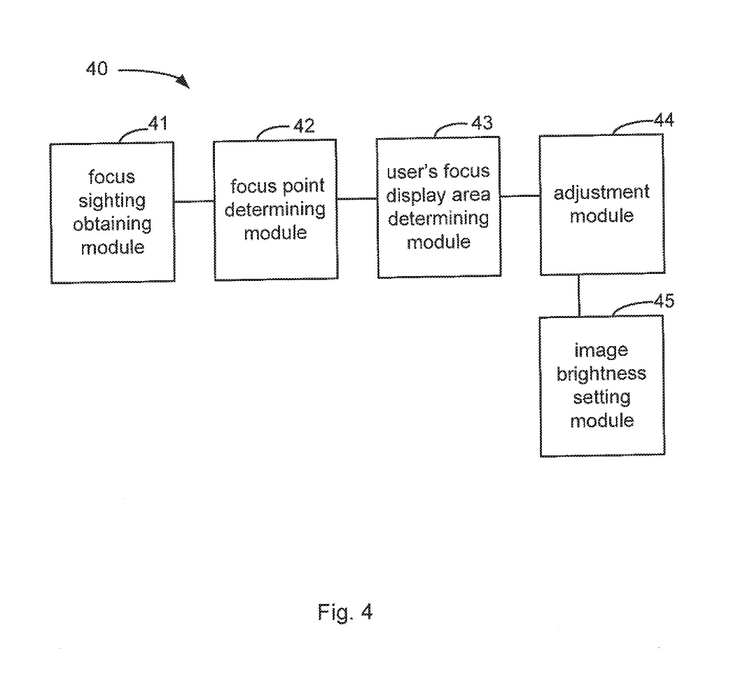

Refer to FIG. 4, which is a structural schematic view of an image brightness adjusting device according to the second preferred embodiment of the present invention. The image brightness adjusting device of the second preferred embodiment can carry out the aforementioned second preferred embodiment of the image brightness adjusting method. The image brightness adjusting device 40 comprises a focus sighting obtaining module 41, a focus point determining module 42, a user's focus display area determining module 43, an adjustment module 44, and an image brightness setting module 45.

The focus sighting obtaining module 41 is configured for obtaining a focus sighting of a user through the eye movement camera. The focus point determining module 42 is configured for determining a focus point of the user on a display screen of the OLED display device according to the focus sighting of the user. The user's focus display area determining module 43 is configured for determining at least one adjustable brightness display area in the user's focus according to the focus point and an eye resolution range. The adjustment module 44 is configured for adjusting the preset brightness reduction curve. The image brightness setting module 45 is configured for setting a screen display brightness of each of the adjustable brightness display areas according to positions of the adjustable brightness display areas in the user's focus and the preset brightness reduction curve.

When the image brightness adjusting device 40 of the preferred embodiment is used, firstly, the focus sighting obtaining module 41 obtains a focus sighting of the user, which is a viewing direction of the user, through the eye movement camera.

Then, the focus point determining module 42 determines the focus point of the user on the display screen of the OLED display device according to the focus sighting of the user obtained from the focus sighting obtaining module 41. Namely, the focus point is a location where the user's eye focuses on the display screen when the user employs the OLED display device.

Thereafter, the user's focus display area determining module 43 is configured for determining one or a plurality of adjustable brightness display areas on which the user is focused according to the focus point obtained from the focus point determining module 42 and an eye resolution range. Namely, the adjustable brightness display areas within the scope of human eye resolution around the focus point are set as the adjustable brightness display areas on which the user is focused.

Then, the preset brightness reduction curve is adjusted by the adjustment module 44. The preset brightness reduction curve refers to a brightness difference curve between the adjustable brightness display areas on which the user's eye is focused and the surrounding adjustable brightness display area thereof. The screen display brightness of the adjustable brightness display area is gradually decreased from the focus point outward. The user can adjust a decreasing ratio of the screen display brightness of the adjustable brightness display area by setting the preset brightness reduction curve, such as accelerating a brightness reducing rate or slowing down the brightness reducing rate, etc.

Finally, the image brightness setting module 45 sets a screen display brightness of each of the adjustable brightness display areas according to positions of the adjustable brightness display areas on which the user is focused and the preset brightness reduction curve obtained from the adjustment module 44. Specifically, the screen display brightness of the adjustable brightness display areas closer to the focus point is greater than the screen display brightness of the adjustable brightness display areas far away from the focus point.

Preferably, in the preferred embodiment, the screen display brightness of the adjustable brightness display area from the focus point which is greater than or equal to a first setting value can be set to zero by the image brightness setting module 45. This is equivalent to reducing the display panel of the OLED display device, so that the power consumption of the OLED display device can be further reduced.

Preferably, the image brightness setting module 45 is further configured for setting the screen display brightness of each of the adjustable brightness display area according to the positions of the adjustable brightness display areas in the user's focus and a user's focus duration.

Specifically, when the user's focus duration in the adjustable brightness display areas in the user's focus is greater than or equal to a second setting value, meaning the user's attention to the other adjustable brightness display areas is relatively low, the screen display brightness of the adjustable brightness display area outside of the adjustable brightness display area on which the user is focused is lowered by the image brightness setting module 45, thereby further reducing the power consumption of the OLED display device.

Thus, the image brightness adjusting process of the image brightness adjusting device 40 of the preferred embodiment is completed.

On the basis of the first preferred embodiment, the image brightness adjusting device of the preferred embodiment allows the preset brightness reduction curve to be adjusted, which increases an adjustment flexibility of the screen display brightness of the adjustable brightness display area. Simultaneously, the screen display brightness of part of the adjustable brightness display area can be set to zero. Alternately, the screen display brightness of part of the adjustable brightness display area can be lowered according to a user's focus duration, thereby further reducing the power consumption of the OLED display device.

The present invention provides an image brightness adjusting method and an image brightness adjusting device for adjusting a screen display brightness of each of the adjustable brightness display areas according to the user's focus sighting, thereby better lowering the power consumption of the OLED display device and not affecting the user's experience. The present invention solves the problems of higher power consumption and the problems affecting the user's experience in the conventional image brightness adjusting method and image brightness adjusting device.

The present invention has been described with preferred embodiments thereof, and it is understood that many changes and modifications to the described embodiment can be carried out without departing from the scope and the spirit of the invention that is intended to be limited only by the appended claims.

What is claimed is:

1. An image brightness adjusting method for adjusting an image display brightness of an OLED display device, the OLED display device including a plurality of adjustable brightness display areas and an eye movement camera, the method comprising:
obtaining a focus sighting of a user through the eye movement camera;
determining a focus point of the user on a display screen of the OLED display device according to the focus sighting of the user;
determining at least one adjustable brightness display area in the user's focus according to the focus point and an eye resolution range; and
setting a screen display brightness of each of the adjustable brightness display areas according to positions of the adjustable brightness display areas in the user's focus;
wherein the screen display brightness of the adjustable brightness display areas closer to the focus point is greater than the screen display brightness of the adjustable brightness display areas far away from the focus point;
wherein the step of setting the screen display brightness of each of the adjustable brightness display areas according to the positions of the adjustable brightness display areas of the user's focus comprises:
setting the screen display brightness of each of the adjustable brightness display areas according to the positions of the adjustable brightness display areas in the user's focus and a user's focus duration; and
wherein when the user's focus duration in the adjustable brightness display areas in the user's focus is greater than or equal to a second setting value, the screen display brightness of the adjustable brightness display areas outside of the adjustable brightness display area on which the user is focused is lowered.

2. An image brightness adjusting method for adjusting an image display brightness of an OLED display device, the OLED display device including a plurality of adjustable brightness display areas and an eye movement camera, the method comprising:
obtaining a focus sighting of a user through the eye movement camera;
determining a focus point of the user on a display screen of the OLED display device according to the focus sighting of the user;
determining at least one adjustable brightness display area in the user's focus according to the focus point and an eye resolution range; and
setting a screen display brightness of each of the adjustable brightness display areas according to positions of the adjustable brightness display areas in the user's focus.

3. The image brightness adjusting method according to claim 2, wherein the screen display brightness of the adjustable brightness display areas closer to the focus point is greater than the screen display brightness of the adjustable brightness display areas far away from the focus point.

4. The image brightness adjusting method according to claim 2, wherein the step of setting the screen display brightness of each of the adjustable brightness display areas according to the positions of the adjustable brightness display areas in the user's focus comprises:
setting the screen display brightness of each of the adjustable brightness display areas according to the positions of the adjustable brightness display areas in the user's focus and a preset brightness reduction curve.

5. The image brightness adjusting method according to claim 4, wherein the image brightness adjusting method further comprises:
adjusting the preset brightness reduction curve.

6. The image brightness adjusting method according to claim 2, wherein the step of setting the screen display brightness of each of the adjustable brightness display areas according to the positions of the adjustable brightness display areas in the user's focus comprises:
setting the screen display brightness of the adjustable brightness display area whose distance from the focus point is greater than or equal to a first setting value to zero.

7. The image brightness adjusting method according to claim 2, wherein the step of setting the screen display brightness of each of the adjustable brightness display areas according to the positions of the adjustable brightness display areas in the user's focus comprises:
setting the screen display brightness of each of the adjustable brightness display areas according to the positions of the adjustable brightness display areas in the user's focus and a user's focus duration.

8. The image brightness adjusting method according to claim 7, wherein when the user's focus duration in the adjustable brightness display areas in the user's focus is greater than or equal to a second setting value, the screen display brightness of the adjustable brightness display areas outside of the adjustable brightness display area on which the user is focused is lowered.

9. An image brightness adjusting device for adjusting an image display brightness of an OLED display device, the OLED display device includes a plurality of adjustable brightness display areas and an eye movement camera, the device comprising:
a focus sighting obtaining module for obtaining a focus sighting of a user through the eye movement camera;
a focus point determining module for determining a focus point of the user on a display screen of the OLED display device according to the focus sighting of the user;
a user's focus display area determining module for determining at least one adjustable brightness display area in the user's focus according to the focus point and an eye resolution range; and
an image brightness setting module for setting a screen display brightness of each of the adjustable brightness display areas according to positions of the adjustable brightness display areas in the user's focus.

10. The image brightness adjusting device according to claim 9, wherein the screen display brightness of the adjustable brightness display areas closer to the focus point is greater than the screen display brightness of the adjustable brightness display areas far away from the focus point.

11. The image brightness adjusting device according to claim 9, wherein the image brightness setting module is configured for setting the screen display brightness of each of the adjustable brightness display areas according to the positions of the adjustable brightness display areas in the user's focus and a preset brightness reduction curve.

12. The image brightness adjusting device according to claim 11, wherein the image brightness adjusting device further comprises:
an adjustment module for adjusting the preset brightness reduction curve.

13. The image brightness adjusting device according to claim 9, wherein the image brightness setting module is configured for setting the screen display brightness of the adjustable brightness display area whose distance from the focus point is greater than or equal to a first setting value to zero.

14. The image brightness adjusting device according to claim 9, wherein the image brightness setting module is configured for setting the screen display brightness of each of the adjustable brightness display areas according to the positions of the adjustable brightness display areas in the user's focus and a user's focus duration.

15. The image brightness adjusting device according to claim 14, wherein when the user's focus duration in the adjustable brightness display areas in the user's focus is greater than or equal to a second setting value, the screen display brightness of the adjustable brightness display areas outside of the adjustable brightness display area on which the user is focused is lowered.
